(19) United States
(12) Patent Application Publication
(10) Pub. No.: US 2012/0009032 A1
(43) Pub. Date: Jan. 12, 2012

(54) Hole Saw Plug Ejector and Method

(76) Inventor: Philip L. GRUSSENMEYER, Springfield, IL (US)

(21) Appl. No.: 12/834,508

(22) Filed: Jul. 12, 2010

(51) Int. Cl. B23B 51/04; B23P 11/00

(52) U.S. Cl. 408/204; 29/428

(57) ABSTRACT

A hole saw plug ejector includes a mandrel having a threaded end and a hole saw cup with cutting teeth on a leading edge to cut a hole in material. A pilot bit is provided in the hole saw cutting end of the mandrel. A retaining nut for holding the hole saw cup to the mandrel includes inner and outer threads. The inner threads engage the threads on the mandrel and an ejector spring engages the outer threads to provide a simplified system for changing ejector spring sizes for different sizes of hole saw cups.

### REFERENCE TO MICROFICHE APPENDIX

Not applicable.

### BACKGROUND OF THE INVENTION

1. Field of the Invention

This invention relates to the field of hole saws. In particular, the invention relates to a hole saw plug ejector that ejects the plug formed when a hole saw cuts a plug of material.

2. Description of the Related Art

Hole saws and hole saw ejectors are generally known in the art. When a conventional hole saw drills a hole, the circular cut out portion (referred to herein as the plug), which is formed from the cutting teeth of the hole saw cup, can get stuck inside the hole saw cup. Attempts have been made to eject the cut out portion. For example, U.S. Pat. No. 5,934,845 (“the '845 patent”) shows a hole saw ejector having a tapered pilot bit and conical spring member. The conical spring in the '845 patent is used for ejecting the cut out portion.

Hole saws are used to cut many different materials, including but not limited to wood, metal, plastic and concrete. Some materials can be very difficult and time consuming to remove from the hole saw cup.

When springs have been used as a plug ejector, there has been an inadequate structure to attach the spring inside of the hole saw cup. It would be desirable to have a structure and method that includes a way to attach easily the spring to the inside of the hole saw cup and a structure that allows for various sizes of hole saw cups that are used to form various sizes of holes.

### BRIEF SUMMARY OF THE INVENTION

It is an object of the invention to provide a hole saw plug ejector that simplifies the ejection of the plug and that is useable on a wide range of sizes of hole saw cups and plug ejector springs. The inventive hole saw plug ejector generally comprises a mandrel having a threaded end and a substantially cylindrical saw blade cup having a leading edge. The leading edge of the hole saw cup includes cutting teeth for cutting a hole. A pilot bit is normally connected to the mandrel and the mandrel is connected to the saw blade cup. A retaining nut is included that has inner and outer threads. The retaining nut is threaded onto the threaded end of the mandrel. An ejector spring is threaded onto the outer threads of the retaining nut, whereby the spring ejects a cut hole that is formed by the saw blade cup.

A snap ring groove can be provided at the distal end of the threads on the threaded end of the mandrel. A snap ring in the snap ring groove prevents the retaining nut from loosening up while allowing for simplified installation of the retaining nut. Because the snap ring prevents the retaining nut from loosening up, minimal torque need be imposed on the retaining nut. This will actually allow for the user to thread the retaining nut onto the mandrel by hand, thereby preventing over torque or wrench damage to the outer threads on the retaining nut.

The outer thread diameter and the corresponding inner ejector spring diameter can increase as the hole size cup increases. Also, the ejector spring cross-section can be increased so that additional spring force is provided for larger plugs in larger hole saw cups. In this way, various size springs and spring force can be provided to assist with the removal of different sized plugs.

Typically the inner threads on the retaining nut are universal fine threads and the outer threads on the retaining nut are universal course threads.

### BRIEF DESCRIPTION OF THE DRAWINGS

FIG. 1 is an isometric view of the inventive hole saw plug ejector.

FIG. 2 is an assembly view of FIG. 1.

FIG. 2A shows the ejector spring with an optional disk.

FIG. 3 is a sectional view of the inventive hole saw plug ejector taken from line 3-3 of FIG. 1.

FIG. 4 is a partial sectional view taken from FIG. 3.

FIG. 5 is a sectional view taken from line 5-5 of FIG. 4.

FIG. 6 is a partial sectional view of the inventive device showing one of several possible sizes of the retaining nut and ejector spring.

FIG. 7 is a partial sectional view of the inventive device showing one of several possible sizes of the retaining nut and ejector spring with the hole saw cup, ejector spring and retaining nut being larger than the hole saw cup, ejector spring and retaining nut shown in FIG. 6.

FIG. 8 is a partial sectional view of the inventive device showing one of several possible sizes of the retaining nut and ejector spring with the hole saw cup, ejector spring and retaining nut being larger than the hole saw cup, ejector spring and retaining nut shown in FIG. 6 or 7.

### DETAILED DESCRIPTION OF THE INVENTION

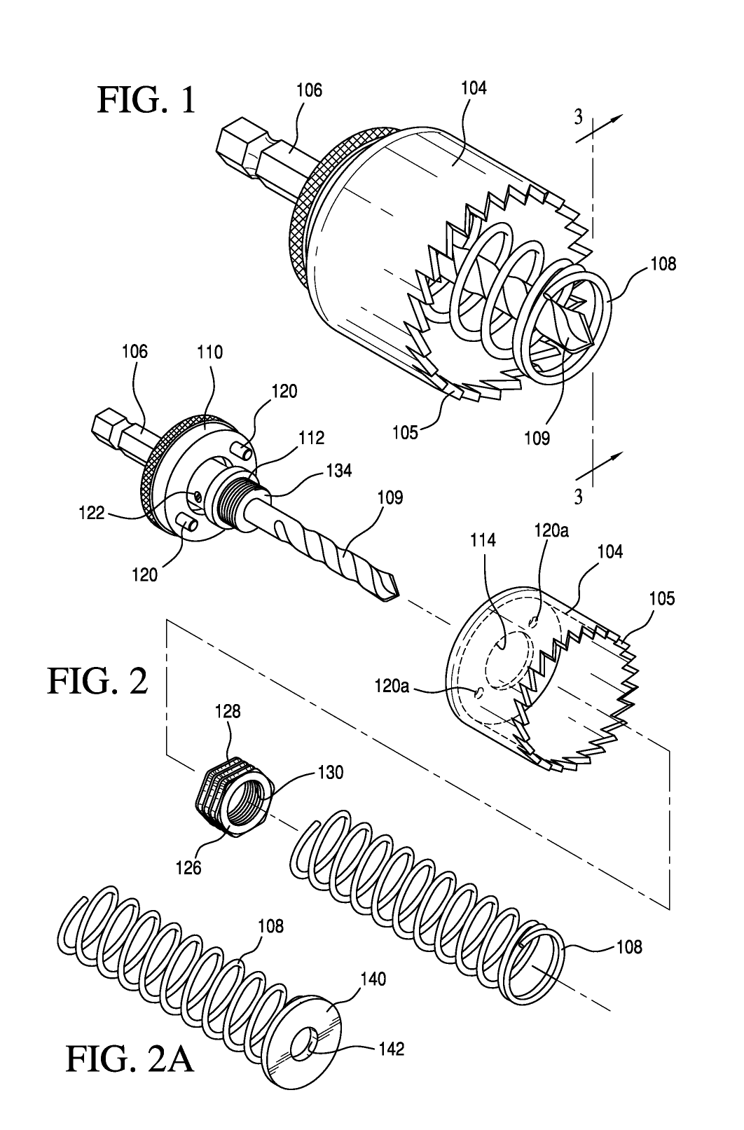

Referring now to FIG. 1, a perspective view of the inventive hole saw plug ejector is shown. Also refer to FIG. 2 in which an assembly drawing of FIG. 1 is shown. A conventional hole saw cup 104 includes cutting teeth 105. The cutting teeth 105 are used to cut a hole in the desired material to the diameter of the hole saw cup 104. An arbor 110 is inserted into the hole 114 in the hole saw cup 104. Pins 120 may be included on the arbor 110 which fit into anti-rotation holes 120a on the top of the hole saw cup 104. When the pins 120 are engaged with the anti-rotation holes 120a, they prevent the hole saw cup 104 from rotating when it is being used to cut a hole in material. The shank 106 is secured and rotated by a power or hand drill (not shown).

Retaining nut 126 typically has inner threads 130 and outer threads 128. The inner threads 130 thread onto the arbor threads 112 to secure the hole saw cup 104 to the arbor 110. A pilot bit 109 is inserted into the arbor end 134 and is typically secured with a setscrew 122 (shown in FIG. 2). The pilot bit 109 is used to provide an accurate starting position for the hole saw cup 104 when beginning the cutting of a hole in the desired material.

The ejector spring 108 is normally threaded onto the outer threads 128 of the retaining nut 126. The outer threads 128 on the retaining nut 126 provide a simple and secure connection between the retaining nut 126 and the ejector spring 108. The outer threads 128 also allow for multiple sizes of retaining nuts 126 to be provided with multiple sizes of ejector springs 108 and multiple sizes of hole saw cups 104. The retaining nuts 126, ejector springs 108 and hole saw cups 104 may be provided for example, as a kit for end users.

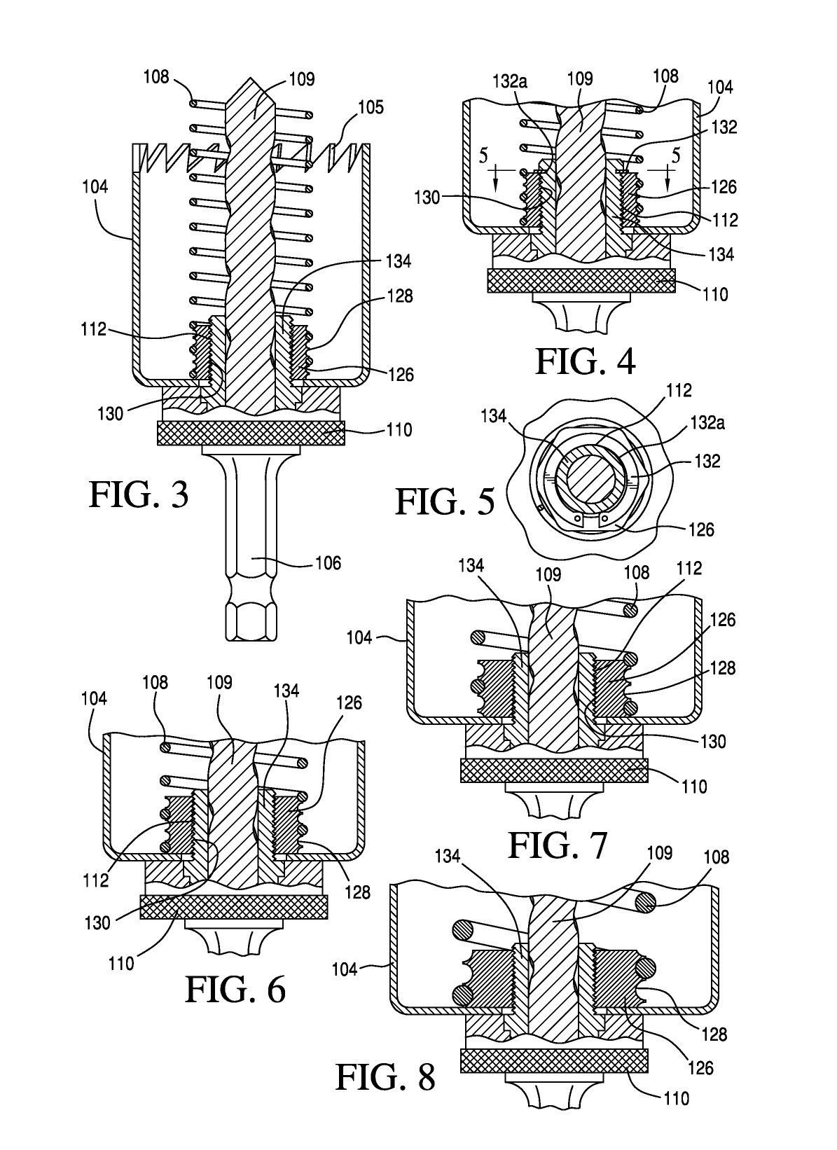

Refer now to FIG. 3, in which a cross section view taken from line 3-3 from FIG. 1 is shown. The ejector spring 108 is shown threaded onto the outer threads 128 of the retaining nut 126. The outer end of the ejector spring 108 is shown extending beyond the cutting teeth 105 of the saw hole cup 104 but below the end of the pilot bit 109. This allows the pilot bit 109 to begin the pilot hole without the ejector spring 108 interfering with the positioning of the pilot bit 109 when drilling the pilot bit hole. After a hole has been drilled with the pilot bit 109, the ejector spring 108 is then compressed against the plug to build up the potential energy stored in the ejector spring 108. After a hole has been cut with the hole saw cup 104, the energy in the compressed ejector spring 108 is released against the plug to eject it from the inside of the hole saw cup 104. It is contemplated that a substantially flat disk 140 as shown in FIG. 2A may be placed, welded or otherwise secured on the distal end of the ejector spring 108 if desired. The disk 140 includes a hole 142 for the pilot drill 109 to pass through. The disk 140 can reduce friction between the end of the ejector spring 108 and the material that is being cut.

Referring to FIG. 4, a snap ring 132 is shown in a snap ring groove 132a. The snap ring groove 132a is positioned at the distal end of the arbor threads 112 and above the retaining nut 126 when the retaining nut 126 is substantially threaded onto the arbor threads 112. The arbor end 134, top of retaining nut 126 and snap ring 132 are also shown in FIG. 5, which is a section view taken along line 5-5 from FIG. 4. The snap ring 132 secures the retaining nut 126 on the arbor threads 112 even if the retaining nut 126 is not fully tightened. This can be important because the retaining nut outer threads 128 might be damaged if excessive torque were to be applied to them when the retaining nut 126 is being threaded onto the arbor threads 112. Moreover, the retaining nut 126 can be tightened by hand, which will also avoid damaging the outer threads 128 and will allow the easy change out of different retaining nuts 126 to be used with different sized ejector springs 108.

The retaining nut inner threads 130 are normally universal fine threads and the retaining nut outer threads 128 are normally universal course threads. The ejector spring 108 inner diameter corresponds to the size of the retaining nut outer thread 128 diameter. The retaining nut inner threads 130 and outer threads 128 are normally right hand but they may also be left hand threads, if desired.

In FIG. 6 the hole saw cup 104 is shown larger than the hole saw cup 104 in FIGS. 3 and 4. The outer diameter of the retaining nut 126 is also shown larger than the retaining nut 126 shown in FIGS. 3 and 4. The outer diameter of the retaining nut 126 is larger so that the larger ejector spring 108 can be threaded onto the retaining nut outer threads 128.

In FIG. 7 the hole saw cup 104 is shown larger than the hole saw cup 104 in FIGS. 3, 4 and 6. The outer diameter of the retaining nut 126 is also shown larger than the retaining nut 126 shown in FIGS. 3, 4 and 6. The outer diameter of the retaining nut 126 is larger so that the larger ejector spring 108 can be threaded onto the retaining nut outer threads 128. Also note that the cross section of the ejector spring 108 is larger in FIG. 7 than the cross section of the ejector spring 108 in FIGS. 3, 4 and 6. The larger cross section provides the ejector spring 108 with a larger spring constant, which caused it to be stiffer. A stiffer spring will tend to eject a plug with more force than a less stiff spring that has a lower spring constant. Also note that the threads on the retaining nut outer threads 128 correspond to both the inner diameter and the cross section of the ejector spring 108. The thread pitch of the retaining nut outer threads 128 can also be changed to correspond to the spacing between coils of the ejector spring 108.

In FIG. 8 the hole saw cup 104 is shown larger than the hole saw cup 104 in FIGS. 3, 4, 6 and 7. The outer diameter of the retaining nut 126 is also shown larger than the retaining nut 126 shown in FIGS. 3, 4, 6 and 7. The outer diameter of the retaining nut 126 is larger so that the larger ejector spring 108 can be threaded onto the retaining nut outer threads 128. The cross section of the ejector spring 108 is larger in FIG. 8 than the cross section of the ejector spring 108 in FIGS. 3, 4, 6 and 7. The larger cross section provides the ejector spring 108 with a larger spring constant, which causes it to be stiffer. A stiffer spring will tend to eject a plug with more force than a less stiff spring that has a lower spring constant. Also note that the threads on the retaining nut outer threads 128 correspond to both the inner diameter and the cross section of the ejector spring 108.

While several embodiments and elements of the invention have been shown and described, it should be understood that other variations and elements will be apparent to those skilled in the art. Therefore, it will be understood that the embodiments and elements shown in the drawings and described herein are merely for illustrative purposes, and are not intended to limit the scope of the invention, which is defined by the claims, which follow.

What is claimed is:

1. A hole saw plug ejector comprising:
a. a mandrel having a threaded end;
b. a substantially cylindrical saw blade cup having a leading edge, said leading edge includes cutting teeth;
c. a pilot bit connected to said mandrel and said mandrel connected to said saw blade cup;
d. a retaining nut having inner and outer threads thereon, said retaining nut threaded onto said threaded end of said mandrel; and
e. an ejector spring threaded onto said outer threads of said retaining nut, whereby said spring ejects a cut hole formed by said saw blade cup.

2. A hole saw plug ejector according to claim 1 wherein said mandrel includes a snap ring groove at the distal end of said threads on said mandrel, and a snap ring in said groove whereby said snap ring secures said retaining nut on said mandrel.

3. A hole saw plug ejector according to claim 1 wherein the spring constant increases as the size of the saw blade cup diameter increases.

4. A hole saw plug ejector according to claim 1 wherein said outer thread diameter and the spring diameter increase as the saw blade cup diameter increases.

5. A hole saw plug ejector according to claim 1 wherein said inner threads on said retaining nut and said threaded end of said arbor comprises universal fine threads.

6. A hole saw plug ejector according to claim 1 wherein said outer threads on said retaining nut comprises universal course threads.

7. A method of making a hole saw plug ejector comprising the steps of:
a. providing a mandrel having a threaded end;
b. including a substantially cylindrical saw blade cup having a leading edge, including cutting teeth on said leading edge;
c. connecting a pilot bit to said mandrel and connecting said mandrel to said saw blade cup;
d. providing a retaining nut having inner and outer threads thereon, threading said retaining nut onto said threaded end of said mandrel; and
e. threading an ejector spring onto said outer threads of said retaining nut, whereby said spring ejects a cut hole formed when said pilot bit is used to initiate a holed formed by said saw blade cup.

8. A method of making a hole saw plug ejector according to claim 7 comprising the additional steps of:
a. including a retaining ring groove below said threads on said mandrel; and
b. providing a retaining ring in said groove whereby said retaining ring secures said retaining nut on said mandrel.

9. A method of making a hole saw plug ejector according to claim 7 comprising the additional step of providing universal fine threads on said inner threads of said retaining nut and on said threaded end of said arbor.

10. A method of making a hole saw plug ejector according to claim 7 comprising the additional step of providing universal course threads on said outer threads of said retaining nut.
